(19) United States
(12) Patent Application Publication
(10) Pub. No.: US 2007/0284190 A1
(43) Pub. Date: Dec. 13, 2007

(54) Ladder accessory

(76) Inventor: Serayah Saul Chady, Chicago, IL (US)

Correspondence Address: GREER, BURNS & CRAIN, 300 S WACKER DR, 25TH FLOOR, CHICAGO, IL, 60606, US

(21) Appl. No.: 11/803,073

(22) Filed: May 11, 2007

Related U.S. Application Data
(63) Continuation-in-part of application No. 11/451,829, filed on Jun. 13, 2006.

(51) Int. Cl. E06C 7/42

(52) U.S. Cl. 182/107

(57) ABSTRACT

A ladder accessory configured for releasable attachment to a side of a ladder rail includes a shoe assembly having at least one of a first shoe and a second shoe, an adapter releasably attached to one of the first and second shoe, the assembly constructed and arranged for increasing traction between a standard ladder foot and a ground surface by engaging the foot without the use of tools.

### RELATED U.S. APPLICATION DATA

This application is a continuation-in-part of co-pending and commonly owned U.S. patent application Ser. No. 11/451,829 entitled LADDER ANCHOR, which is herein incorporated by reference in its entirety.

### BACKGROUND OF THE INVENTION

The present invention generally relates to stability enhancing attachments for ladders used in the construction, home improvement and other industries. More particularly, the present invention relates to an improved ladder accessory configured for preventing ladder slippage on both uneven and even surfaces.

Ladders are well known in the art by both tradesmen and laymen alike, and are often utilized on sloping or uneven ground, where one foot of the ladder is higher than the other. Such use often causes the ladder to be oriented at an angle with respect to the horizontal, reducing the stability of the ladder and sometimes causing the ladder to slip. In other circumstances, ladders are used on even, but slippery surfaces, such as icy ground or smooth flooring. Under such conditions, due to the generally small contact surface area of the ladder feet on the ground surface, ladder stability is reduced, and can cause the ladder to slip.

To maintain ladder stability on uneven surfaces, ladder extension devices have been developed, such as that disclosed in U.S. Pat. No. 1,624,945 to Glover and U.S. Pat. No. 2,145,619 to Brown. In Glover and Brown, the extension device is generally attached to a ladder rail and includes an adjustable spike configured for being embedded into the ground for stabilizing the ladder. However, to attach these devices to the ladder, holes or the like must generally be drilled into the ladder, which is time consuming and can reduce the structural integrity of the ladder. Further, the extension devices provided in Glover and Brown can generally only be removed from the ground with a hammer or other tool, which can be a difficult task if the device is embedded deep into the ground or into wet and unstable ground. In addition, although these devices provide stability on uneven surfaces, they are not suitable for use on even surfaces, such as icy ground and smooth flooring.

Accordingly, to improve ladder stability on even surfaces, current ladders are generally sold with a foot pivotally attached to the base of each ladder rail. The standard ladder foot generally includes a tractioned rubber bottom configured for contacting the ground surface and increasing the contact surface area between the ladder and the ground to prevent ladder movement. However, although the foot may aid in preventing slippage on some surfaces, it does not adequately prevent slippage on icy or unstable surfaces because the rubber bottom does not positively engage the surface. To address this problem, U.S. Pat. No. 7,000,731 to Swiderski discloses a shell configured for engaging the ladder rail and a tread configured for engaging the shell. The shell is constructed and arranged for receiving several different treads with differing tractions/grooves for engagement of several ground surfaces.

Although the cover in Swiderski is configured for use on several types of ground surfaces, the contact surface area of the cover (i.e., the area of the foot in direct contact with the ground surface) is slightly smaller than the area of the ladder rail base, and accordingly the foot may not provide enough traction to sufficiently prevent slippage. Similarly, standard ladder feet generally have a contact surface area of approximately two square inches, and may not provide adequate traction on icy or slippery surfaces.

This problem was addressed in U.S. Pat. No. 7,073,629 to Gardner et al., which discloses a step or foldable ladder support apparatus configured for attachment to ladder rails. In Gardner, a left elongate member is configured for attachment to the left front and rear legs of the ladder, and a right elongate member is configured for attachment to the right front and rear legs of the ladder. The left and right elongate members extend between the front and rear legs of the ladder, and also extend past the legs, to provide two elongated support feet for the ladder. However, the support apparatus in Gardner is bulky and is only suitable for use in open spaces where there is adequate room for the elongate members. Further, the support apparatus in Gardner is designed for use with foldable ladders, and accordingly is not designed to accommodate standard extension ladders. In addition, the support apparatus in Gardner requires the use of tools for attachment to and detachment from the ladder legs.

Also, current extension ladder feet generally only provide support at the base of the ladder rail, and accordingly, because most of the weight is placed on the ladder foot during use, the ladder can still slip or be unstable.

Accordingly, there is a need for an improved ladder accessory that can be used on both uneven and even surfaces. There is also a need for an improved ladder accessory that provides increased traction on icy or smooth surfaces compared to current ladder feet. There is further a need for an improved ladder accessory that provides a relatively larger contact surface area between the ladder and the ground for improving stability of the ladder. There is also a need for an improved ladder accessory that does not require alteration of the ladder to attach the device to the ladder. Further, there is a need for an improved ladder accessory that is configured for increasing stability of the ladder during use.

### BRIEF SUMMARY OF THE INVENTION

The above-identified needs are met or exceeded by the present ladder accessory that is configured for use on both uneven and even surfaces. The present ladder accessory further provides a greater ground contact surface area compared to current ladders and ladder feet. Also, the present ladder accessory provides stability support to the ladder at two locations, dispersing weight and pressure on the ladder more evenly than current ladder feet, which generally place the weight on one point. Further, the present ladder accessory can be easily attached to and removed from the ladder rail without decreasing the structural integrity of the ladder.

More specifically, a ladder accessory configured for releasable attachment to a ladder rail includes a shoe assembly including at least one of a first shoe and a second shoe and an adapter releasably attached to one of the first shoe and the second shoe, the assembly constructed and arranged for increasing traction between a standard ladder foot and a ground surface by engaging the foot without the use of tools.

### BRIEF DESCRIPTION OF THE SEVERAL VIEWS OF THE DRAWINGS

FIG. 1 is a fragmentary side perspective view of a ladder showing the present ladder accessory attached to a ladder rail;

FIG. 2 is a side perspective view showing a cam assembly for attachment of the ladder accessory to the ladder rail;

FIG. 3 is an exploded perspective view of a shoe assembly of the present ladder accessory;

FIG. 4 is a bottom perspective view of a first shoe having a rubber-like pad configured for attachment to the ladder foot;

FIG. 5 is a bottom perspective view of a second shoe having a plurality of spikes configured for attachment to the ladder foot;

FIG. 6 is a fragmentary side perspective view of the present ladder accessory detached from the shoe assembly and configured for use on uneven ground;

FIG. 7 is a fragmentary front elevational view of the present ladder accessory showing a jack arm engaging a spike jacking point;

FIG. 8 is a close-up vertical cross-section taken from point 8 of FIG. 7 of the jack arm engaging the spike jacking point; and

FIG. 9 is a fragmentary front elevational view of the present ladder accessory showing the jack arm engaging the spike jacking point and raising the spike from the ground.

### DETAILED DESCRIPTION OF THE INVENTION

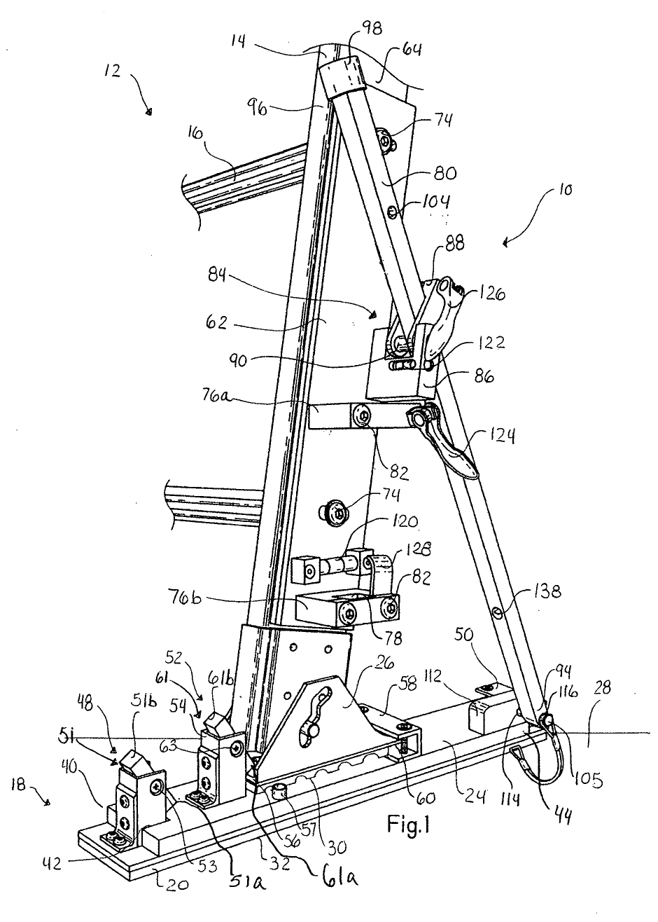

Referring now to FIG. 1, the present ladder accessory is generally designated 10 and is configured for attachment to a ladder 12. As generally known in the art, the ladder 12 includes a pair of spaced, parallel rails 14 and a plurality of rungs 16 constructed and arranged between the rails in a transverse, spaced parallel orientation. The ladder 12 is generally manufactured from a combination of stainless steel, aluminum and/or fiberglass, according to industry-accepted standards as known in the art. The ladder accessory 10 is constructed and arranged for attachment to one of the rails 14, and preferably a fiberglass rail, however the accessory is mountable on aluminum or other metal rails as well.

Referring to FIGS. 1 and 3-5, the ladder accessory 10 includes a shoe assembly 18 including at least one of a first shoe 20 and a second shoe 22, and an adapter 24 releasably attached to either shoe. The assembly 18 is constructed and arranged for increasing traction between a standard ladder foot 26 and a ground surface 28 by engaging the foot, preferably at a foot contact surface 30 without the use of tools. It will be understood that “contact surface” refers to the area of the ladder foot 26 or other component that is in direct contact with the ground surface 28 during ladder use. Generally, the foot contact surface 30 of the standard ladder foot 26 is constructed of a rubber-like, ribbed bottom 27 and provides approximately two square inches of direct contact with the ground 28, where a shoe contact surface 32 of the first and second shoes 20, 22 is approximately 30 square inches, although other sizes for the shoe contact surface 32 are contemplated. Because the area of the shoe contact surface 32 is larger than the area of the foot contact surface 30, it is contemplated that the stability of the ladder 12 is increased because of the increased contact with the ground 28.

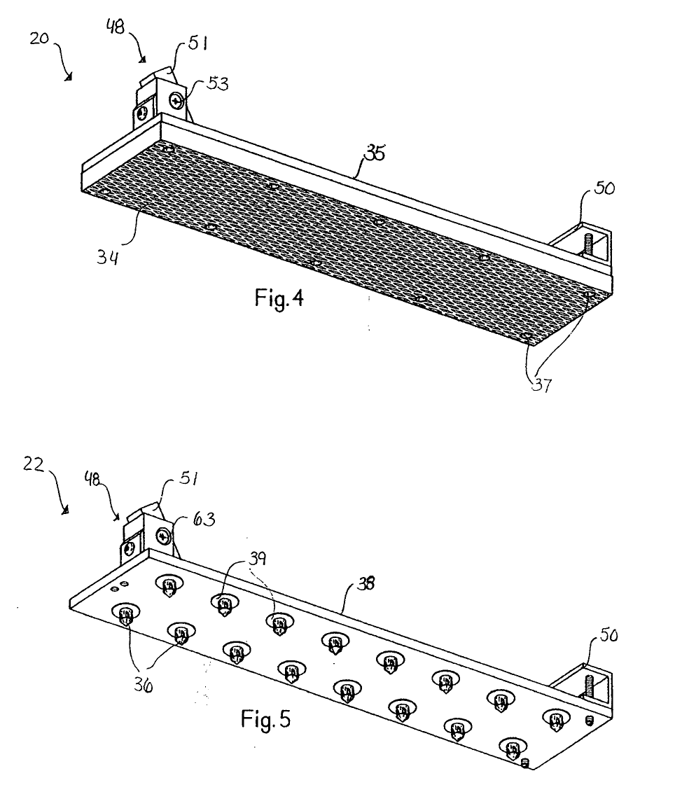

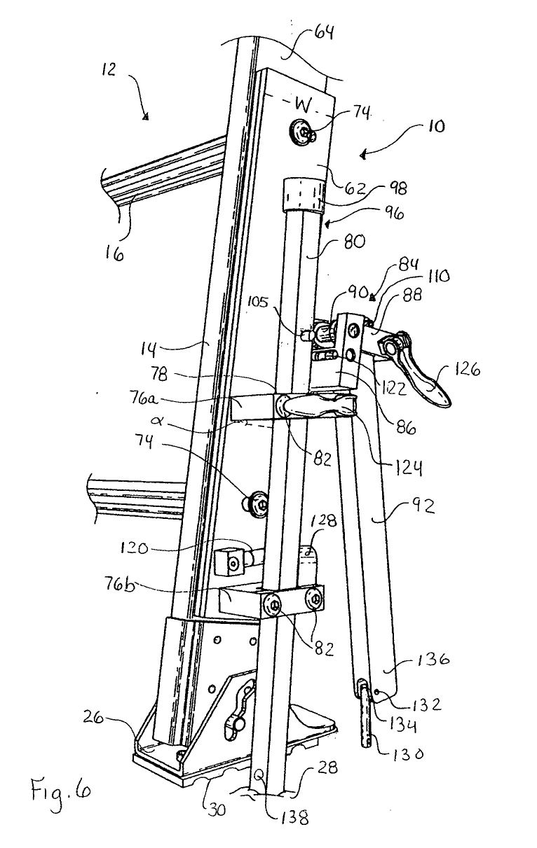

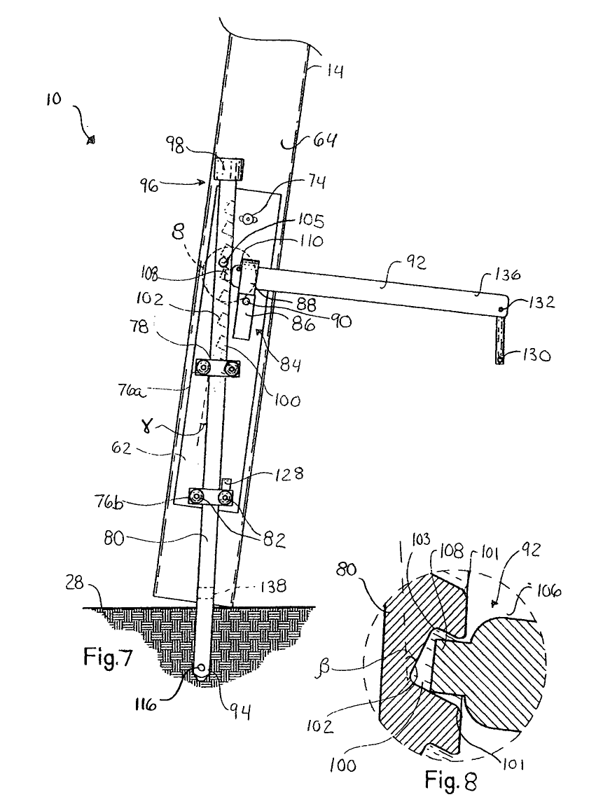

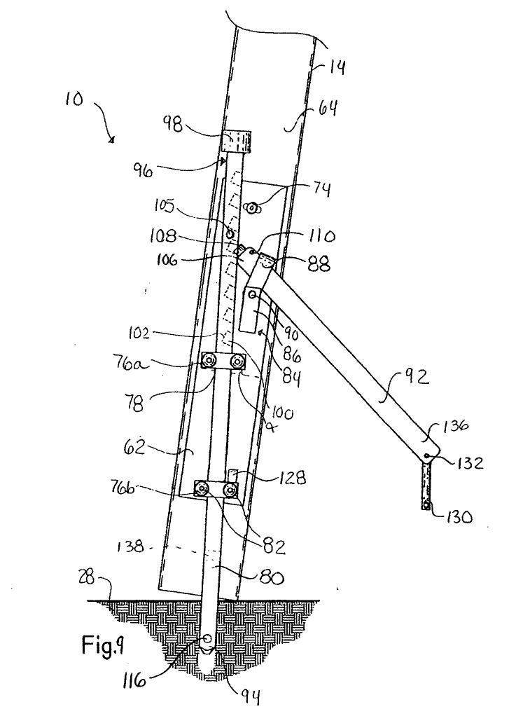

As seen in FIGS. 4 and 5, the first shoe 20 includes a rubber-like pad 34 attached to a bottom surface of a plate member 35 of the first shoe, and the second shoe 22 includes a plurality of spikes 36 extending from a bottom surface of a plate member 38 of the second shoe. The rubber-like pad 34 and the spikes 36 are configured for engaging and increasing traction on the ground surface 28 or smooth, slippery surfaces, such as tile or marble flooring, although it is appreciated that other bottom surfaces for the shoes 20, 22 may be suitable depending on the application, such as a moldable thermoplastic or elastomer, ribs or the like.

The rubber-like pad 34 is preferably attached to the first shoe plate member 35 by a plurality of fasteners passing through grommets 37, although it is appreciated that adhesive or other means of attachment may be suitable.

The spikes 36 are configured for positively engaging and providing traction on icy surfaces for preventing movement or slippage of the ladder 12 during use. As seen in FIG. 5, the spikes 36 are preferably arranged in spaced, parallel rows extending along the bottom of the second shoe plate member 38 to provide an even and level contact surface. The spikes 36 are preferably threaded into both the second shoe plate member 38 and a plurality of “t-nuts” 39 extending from the bottom of the second plate member. It is contemplated that the t-nuts 39 securely retain and provide lateral support to the spikes to relieve the stress caused by continued ladder use. However, it is recognized that alternative fastening techniques for the spikes 36 are possible such as welding, depending on the application. The spikes 36 are preferably set screws manufactured from hardened steel, although other similar materials are contemplated. After continued use, the spikes 36 can become worn down, and it is contemplated that the spikes can easily be replaced by unthreading them from the t-nuts 39 and the second plate member 38.

It is contemplated that the first and second shoes 20, 22 provide increased traction on a greater variety of surfaces than current ladder feet. As will be explained in further detail below, the shoes 20, 22 are interchangeable on the adapter 24 without the use of tools for allowing the user to easily use the ladder 12 on both icy and smooth surfaces.

Referring to FIGS. 3-5, the adapter 24 includes a first end 40 defining a notch 42 and a second end 44 having a protrusion 46. To enable releasable attachment of the first and second shoes 20, 22 to the adapter 24, the shoes each preferably include a first latch release 48 constructed and arranged for engaging the notch 42, and a first bracket 50 constructed and arranged for receiving the protrusion 46. The first bracket 50 is preferably “C-shaped” for receiving the protrusion 46, although other shapes may be appropriate. The first latch release 48 includes a first spring-loaded latch 51 arranged on and pivoting about a first rod 53, enabling the shoes 20, 22 to be removed from the adapter 24 without the use of tools, as described below.

To attach the adapter 24 to the shoes 20, 22, the user slides the protrusion 46 into the C-shaped bracket 50 and presses the first end 40 downwardly such that the latch 51 is received in the notch 42 and pivots about the first rod 53 overcoming the biasing force. Once the adapter 24 is seated on the plate member 35 or 38, the latch 51 is released such that a lower end 51a extends over a portion of the adapter first end 40, locking the adapter in place. (FIG. 1). To release the adapter 24, the user presses against an upper end 51b of the latch 51, overcoming the biasing force and allowing removal of the adapter 24. Because the shoes 20, 22 can be attached to and removed from the adapter 24 without the use of tools, it is contemplated that the user can easily interchange the shoes based on the type of surface on which the ladder 12 is used.

To provide releasable attachment of the shoe assembly 18 to the ladder foot 26, the adapter 24 preferably includes a mounting assembly 52 having a second latch release 54 constructed and arranged for engaging a front end 56 of the ladder foot, and a second “C-shaped” bracket 58 constructed and arranged for receiving a rear end 60 of the ladder foot. The second latch release 54 includes a second spring-loaded latch 61 pivotally arranged on a second rod 63, although other types of releases are contemplated for attaching the adapter 24 to the foot 26, such as a snap-fit latch. To attach the shoe assembly 18 to the ladder foot 26, the user slides the rear end 60 into the second C-shaped bracket 58 and pushes the assembly upwardly, pivoting a lower end 61a of the second latch 61 about the second rod 63 to overcome the biasing force of a spring (not shown). Once the foot 26 is in contact with the adapter 24, the lower end 61a of the latch 61 engages the front end 56, locking the assembly to the foot. (FIG. 1). To further retain the foot 26 to the adapter 24, the adapter includes a pair of bolts 57, preferably Allen bolts, provided on opposite sides of the adapter between the second bracket 58 and the second latch release 54. Preferably, the bolts 57 are located proximal to the second latch release 54 and have an approximate height of ⅜ inch so they extend above the rubber-like bottom 27 of the ladder foot 26, preventing lateral movement of the front end 56 of the foot relative to the adapter 24.

Once the user decides to remove the shoe assembly 18 from the ladder 12, the latch 61 is released similar to the latch 51, by the user pressing against an upper end 61b of the latch to overcome the biasing force. It is contemplated that by providing releasable attachment of the foot 26 to the adapter 24 without the use of tools, the user can easily remove the shoe assembly 18 when the ladder is not in use or when it is used on uneven ground, which is described in further detail below.

Referring now to FIGS. 1 and 6, the ladder accessory 10 further includes a frame 62 being attached to the ladder rail 14 on an outside surface 64 of the rail. The frame 62 preferably has a width “W” generally corresponding to the width of the rails 14, and is preferably manufactured from aluminum, but it is recognized that other similar materials may be suitable.

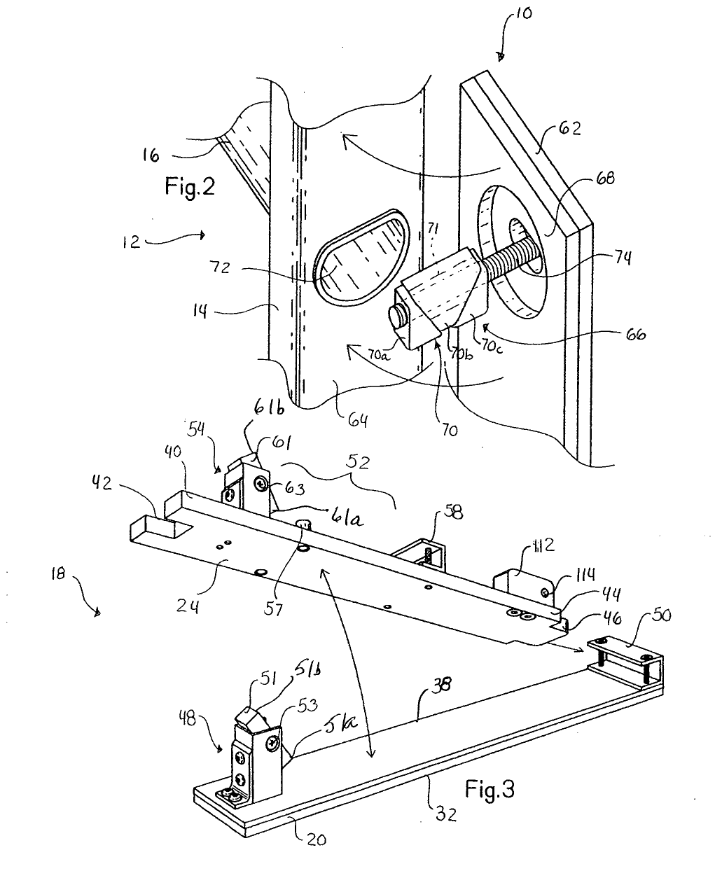

Referring to FIG. 2, to attach the frame 62 to the ladder rail 14, the accessory 10 includes at least one cam assembly 66 attached to a backside 68 of the frame. The cam assembly 66 includes at least one radially expanding element 70 that frictionally engages an inner diameter 72 of the rung 16 for achieving a secure friction fit between the frame and the rail 14. Preferably, the at least one radially expanding element 70 is at least one wedge arranged on a threaded shaft 74 extending from the frame backside 68. Preferably still, the at least one wedge 70 is three wedges 70a, 70b, 70c arranged offset from each other on the shaft 74. The outer wedges 70a, 70c are threadably engaged on the shaft 74, and the center wedge 70b defines a channel 71 (shown hidden in FIG. 2) that loosely receives the shaft 74. The circumference of the channel 71 is preferably larger than the circumference of the shaft 74 to enable movement of the center wedge 70b with respect to the shaft.

The wedges 70a, 70b, 70c each preferably have a partially radiused cross-section provided to ensure proper insertion of the wedges 70 into the hollow rung 16, which in standard ladders is generally “D-shaped.” To attach the frame 62 to the ladder rail 14, the user orients the wedges 70 such that the partially radiused cross-section is proximal to the radiused edge of the rung inner diameter 72, and inserts the wedges into the hollow rung 16. The user then tightens the shaft 74 using a tool such as an Allen wrench or the like, causing the outer wedges 70a, 70c, which are threaded onto the shaft, to be tightened toward each other. As the outer wedges 70a, 70c move toward each other, they push the center wedge 70b along the channel 71 and radially away from the shaft, radially expanding the diameter of the cam assembly 66 to tightly engage the rung interior diameter 72, securing the frame 62 to the rail 14 with a secure friction fit.

Because the attachment of the frame 62 to the rail 14 does not require the user to drill holes into the rail or otherwise alter the ladder 12, the structural integrity of the ladder is maintained. Further, it is contemplated that the present cam assembly 66 enables the user to quickly and easily attach and detach the accessory 10 to the ladder 12, although it is recognized that other attachment devices may be appropriate, depending on the application.

As seen in FIG. 6, the frame 62 further includes at least one guide bracket and preferably a pair of linearly spaced guide brackets 76a, 76b each defining a channel 78 constructed and arranged for slidably receiving a spike 80 configured for either embedment into the ground or attachment to the adapter 24, which will be described in further detail below. The guide brackets 76a, 76b are preferably arranged on the frame 62 substantially parallel to and offset from each other, at an approximate 22° angle α relative to a longitudinal axis of the frame. The guide brackets 76a, 76b are secured to the frame 62, preferably by fasteners 82, although welds, integral molding, and adhesives are also contemplated for securing the brackets to the frame. Although other similar materials are contemplated, the brackets 76a, 76b are preferably manufactured from a lightweight and durable metal, such as aluminum, and are preferably integrally formed for attachment to the frame 62.

The frame 62 further includes a linkage 84 including a support bracket 86 and a pivot bracket 88 pivotally attached to a first end of the support bracket at a tubular pivot bushing 90. The pivot bracket 88 is constructed and arranged for receiving a jack arm 92 and enabling the jack arm to operationally engage the spike 80, removing it from the ground 28, as described below in further detail and as disclosed in commonly-owned U.S. patent application Ser. No. 11/451,829 entitled LADDER ANCHOR, herein incorporated in full by reference.

Referring to FIGS. 6, 7 and 9, the spike 80 has an embedment end 94 having a generally pointed shape and a contact end 96 preferably having a removable spike cap 98. As known in the art, the spike embedment end 94 is configured for piercing the ground 28. It is contemplated that the spike 80 can be hammered up to approximately 8 inches into the ground 28, unlike current ladder anti-slippage devices, which generally are only embedded approximately one inch into the ground. Further, because the guide brackets 76a, 76b are oriented at the 22° angle α relative to the longitudinal axis of the frame, the spike 80 is received in the guide brackets 76a, 76b at an approximate 22° angle γ relative to the longitudinal axis of the frame 62. It is contemplated that by arranging the guide brackets 76a, 76b and the spike 80 at such an angle, the spike will be embedded into the ground 28 at a substantially 90° angle relative to the ground, dispersing the forces on the spike along the longitudinal axis of the spike, rather than concentrating the forces at the embedment end 94, preventing the spike from bending and preventing slippage of the ladder 12. Accordingly, it is contemplated that the ladder accessory 10 provides a more stable and secure attachment within the ground 28 when compared to current devices, decreasing the risk of ladder slippage common in sloping, wet and unstable ground.

The removable spike cap 98 is radially and axially thickened relative to the spike contact end 96 for being repeatedly hammered by the user during operation of the accessory 10, and is therefore subjected to repeated force. Accordingly, the spike cap 98 is removable so that it can be replaced when worn down or damaged due to repeated hammering. It is preferred that the spike cap 98 is manufactured from steel or stainless steel, and is threadably attached to the spike contact end 96, preferably by an internal, threaded stud (not shown), facilitating easy removal and replacement. However, it is recognized that other similar materials or means of attachment are suitable, as known in the art.

In current ladder anti-slippage devices, damage can be caused to the ladder rail during hammering of the spike into the ground 28. Accordingly, in the present ladder accessory 10, the frame 62 has a height of approximately ½ inch, and the guide brackets 76a and 76b have a height of approximately one inch so that the spike 80 is spaced approximately 1½ inches away from the ladder rail 14, providing clearance and preventing damage to the ladder 12 if the user misses the spike cap 98 during hammering.

As shown in FIGS. 7-9, the spike 80 further includes a plurality of linearly spaced jacking points 100. While other dimensions and spacings are contemplated, the jacking points 100 preferably have a ½ inch diameter, and are spaced apart from each other 1 inch from their respective centers. It is contemplated that this spacing allows the jack arm 92 to more efficiently engage the jacking points 100 and remove the spike 80 from the ground 28. It is further preferred that the jacking points 100 are blind end bores extending approximately ⅜ of an inch deep to prevent bending or other damage to the spike 80, increasing the life of the spike. It is contemplated that this arrangement maintains the strength of the spike 80.

The plurality of jacking points 100 preferably each have an axis angled relative to a longitudinal axis of the spike 80, and also preferably have a flat bottom 102 (FIG. 8). More specifically, the jacking points 100 preferably each form an approximate 22° angle β (FIG. 8) with respect to the longitudinal axis of the spike 80, and have radiused or countersunk upper and lower edges 101, 103, respectively, to enable easy removal of the jack arm 92 during operation (FIG. 8). It is contemplated that by arranging the jacking points 100 at the 22° angle β, the jacking arm 92 will readily engage the jacking points and remove the spike 80 from the ground. However, it is appreciated that other angles may be suitable, depending on the application.

The spike 80 further defines a stop hole 104 configured for receiving a removable pin 105 constructed and arranged for preventing the spike from being embedded too deep into the ground 28. The pin 105 projects radially from the spike 80, is preferably located between the spike contact end 96 and the jacking points 100, and is preferably a tubular pin. It is contemplated that if the pin 105 becomes damaged during use of the accessory 10, it can be easily replaced without the need to replace the entire spike 80.

Referring still to FIGS. 7-9, the jack arm 92 includes an engagement end 106 having a knob 108 configured for engaging each of the jacking points 100. The knob 108 is preferably cylindrical in shape and has a smaller diameter than the diameter of the jacking points 100. The jack arm 92 further includes at least one radially projecting stop 110 near the jack engagement end 106 configured for retaining the jack arm in the linkage 84 when the arm is not in use. The jack arm stop 110 is preferably a tubular pin and is accommodated in a pin through hole (not shown) near the jack arm engagement end 106. The jack arm stop 110 is configured for preventing the jack arm 92 from falling out of the pivot bracket 88 during operation of the jack arm. However, it is recognized that other configurations may be suitable, as known in the art.

As seen in FIGS. 6-9, the ladder accessory 10 is moveable between a rest position (FIG. 6) and an operating position (FIGS. 7-9). In the operating position, the jack arm 92 is constructed and arranged for engaging the spike 80 with a sufficient mechanical advantage for manually extracting the spike when embedded in the ground 28, as seen in FIGS. 7 and 9. Specifically, when the user wishes to remove the spike 80 from the ground 28, the user simply pivots the jack arm 92 so that the jack arm knob 108 engages one of the jacking points 100. Once the jack arm knob 108 has engaged the jacking point 100 (FIG. 8), the user actuates the jack arm 92 in a fulcrum motion, which will begin to remove the spike 80 from the ground 28 (FIG. 9). The user continues this process by successively engaging the adjacent jacking points 100 with the jack arm knob 108 until the spike 80 is completely removed from the ground 28.

As stated above, because the jacking points 100 are oriented at approximately the 22° angle β relative to the longitudinal axis of the spike 80, and include radiused or countersunk upper and lower edges 101, 103, respectively, it is contemplated that when the user actuates the jack arm 92, the jack arm knob 108 automatically ejects itself from the jacking point 100, enabling efficient spike removal. It is contemplated that this arrangement is superior to current anti-slippage devices because the ladder accessory 10 does not require any special or remotely located tools to remove the spike 80 from the ground 28.

Referring again to FIG. 1, the shoe assembly 18 is attached to the ladder foot 26, as discussed above, and the spike 80 is not embedded into the ground 28, when the ladder 12 is used on an even surface. To provide further support to the ladder 12, the jack arm 92 is removed from the pivot bracket 88 by pulling the jack arm engagement end 106 upwards and away from the pivot bracket 88. The spike 80 is then slidably received in the pivot bracket 88, embedment end 94 first, enabling attachment of the embedment end to the adapter 24. Prior to sliding the spike 80 into the pivot bracket 88, the user removes the pin 105 from the stop hole 104 such that movement of the spike is not limited in the pivot bracket.

Preferably, the adapter 24 includes a mounting block 112 provided near the adapter second end 44 and defining an opening 114 constructed and arranged for alignment with a through-hole 116 defined in the spike 80. The user then inserts the pin 105 into the opening 114 and the through-hole 116, releasably securing the spike 80 to the mounting block 112. It is contemplated that by providing a second point of attachment that is offset from the ladder foot 26, the pressure and weight on the ladder 12 is dispersed more evenly and increases the stability of the ladder 12 during use, although it is appreciated that other suitable configurations for dispersing the weight of the ladder may be appropriate.

Referring to FIGS. 1 and 6, the frame 62 further preferably includes at least one level and preferably a pair of levels 120, 122 attached to the frame for enabling proper orientation of the ladder 12 on the ground 28. Preferably, the level 120 is arranged at an approximate 75.5° angle relative to the ground 28 for enabling proper placement of the ladder 12 against a substrate at a 75.5° angle relative to the ground, in compliance with industry standards. The level 122 is provided in the support bracket 86 and is arranged substantially perpendicular to the ground 28 for indicating the angular orientation of the ladder once both feet 26 are on the ground.

As seen in FIGS. 1 and 6, the guide bracket 76a and the pivot bracket 88 each preferably include a quick release latch 124, 126, respectively. The latches 124, 126 are preferably over-center cam release latches, similar to bicycle hub retainers, which are known in the art. In a closed position, the latch 124 is constructed and arranged for securely retaining the spike 80 in the guide bracket 76a when the ladder accessory 10 is not in use, and for providing further stability when the spike is embedded in the ground. (FIG. 6). When in the closed position, the latch 126 is configured for retaining the spike 80 in the pivot bracket 88 when the spike is attached to the mounting block 112. (FIG. 1). When the latches 124, 126 are in an open position, the spike 80 and jack arm 92 can be easily removed from their corresponding brackets without the use of tools, so that the spike can be inserted into the pivot bracket 88 for attachment to the mounting block 112. However, other securing apparatuses may be appropriate, depending on the application.

Best seen in FIG. 6, for retaining the spike 80 to the jack arm 92 during transport of the accessory 10, the accessory further includes a pin bracket 128 secured to the frame 62 and the bracket 76a. It is contemplated that the pin bracket 128 can be separately attached to the frame 62 or the bracket 76a, or can be integrally formed with the frame or the bracket, depending on the application. The jack arm 92 further includes a pin 130 pivotally attached to the jack arm by a pivot pin 132 located in a jack arm clevis 134 at a jack arm second end 136. The pivot pin 132 is mounted in the jack arm 92 to be transversely located in the clevis 134, which is configured to provide clearance for the pin 130 within the jack arm second end 136.

To secure the spike 80 to the jack arm 92, the user pivots the pin 130 so it can pass through a spike pinhole 138 that can be aligned with the pin bracket 128. Once the pin 130 passes through the spike 80, it is held in place by a cotter pin (not shown) or other locking device, as known in the art. Although a specific retaining assembly has been discussed herein, it is appreciated that other arrangements for retaining the spike 80 to the jack arm 92 are suitable, as known in the art.

While a particular embodiment of the present ladder accessory has been described herein, it should be appreciated by those skilled in the art that changes and modifications may be made thereto without departing from the invention in its broader aspects and as set forth in the following claims.

1. A ladder accessory configured for releasable attachment to a side of a ladder rail, comprising:
a shoe assembly including at least one of a first shoe and a second shoe;
an adapter releasably attached to one of said first and second shoe;
said assembly constructed and arranged for increasing traction between a standard ladder foot and a ground surface by engaging said foot without the use of tools.

2. The ladder accessory of claim 1 wherein said first shoe includes a first plate member having a rubber-like pad attached thereto, and said second shoe includes a plurality of spikes extending from a second plate member thereof, said rubber-like pad and said spikes configured for engaging said ground surface and increasing traction on said ground surface.

3. The ladder accessory of claim 2 wherein said adapter includes a first end defining a notch and a second end having a protrusion.

4. The ladder accessory of claim 3 wherein said first and second shoes each include a first latch release constructed and arranged for engaging said notch, and a first bracket constructed and arranged for receiving said protrusion.

5. The ladder accessory of claim 3 wherein said adapter includes a mounting assembly constructed and arranged for receiving said ladder foot.

6. The ladder accessory of claim 5 wherein said mounting assembly includes a second latch release constructed and arranged for engaging one end of said ladder foot, and a second bracket constructed and arranged for receiving another end of said ladder foot.

7. The ladder accessory of claim 1 further including a frame having at least one guide bracket and being attached to the ladder rail, and a spike slidably received in said guide bracket and having a distal end configured for releasable attachment to said adapter for stabilizing the ladder during use.

8. The ladder accessory of claim 7 further including at least one level attached to said frame and constructed and arranged for enabling proper orientation of said ladder rail against a substrate.

9. The ladder accessory of claim 7 further including a quick release latch attached to said guide bracket and configured for enabling removal of said spike from said guide bracket without the use of tools.

10. The ladder accessory of claim 1 further including a frame having at least one cam assembly attached to said frame and including at least one radially expanding element for frictionally engaging an inner diameter of a hollow ladder rung for achieving a secure friction fit between said frame and the rail.

11. The ladder accessory of claim 10 wherein each said at least one cam assembly includes a plurality of wedges linearly arranged on a threaded shaft.

12. The ladder accessory of claim 11 wherein said wedges are linearly offset from each other along said shaft and include a pair of outer wedges threadably received on said shaft and a middle wedge defining a channel constructed and arranged for being loosely received on said shaft.

13. The ladder accessory of claim 12 wherein each of said wedges includes a partially radiused cross-section constructed and arranged for insertion into said hollow rung such that upon insertion into said hollow rung, said shaft is tightened by a tool, threadably tightening said outer wedges toward each other and pushing said middle wedge radially away from said shaft along said channel, radially expanding a diameter of said cam assembly and securing said frame to the rail.

14. A ladder accessory configured for attachment to a ladder rail, comprising:
a frame having at least one bracket; and
at least one cam assembly attached to said frame and including at least one radially expanding element for frictionally engaging an inner diameter of a hollow ladder rung for achieving a secure friction fit between said frame and the ladder rail.

15. The ladder accessory of claim 14 wherein said cam assembly includes a plurality of wedges linearly arranged on a threaded shaft extending from a backside of said frame.

16. The ladder accessory of claim 15 wherein said wedges are linearly offset from each other along said shaft and include a pair of outer wedges threadably received on said shaft, and a middle wedge defining a channel constructed and arranged for being loosely received on said shaft.

17. The ladder accessory of claim 15 wherein each of said wedges includes a partially radiused cross-section constructed and arranged for insertion into said hollow rung such that upon insertion into said hollow rung, said shaft is tightened by a tool, threadably tightening said outer wedges toward each other and pushing said middle wedge radially away from said shaft along said channel, radially expanding a diameter of said cam assembly and securing said frame to the rail.

18. A ladder accessory configured for attachment to a ladder rail, comprising:
a frame having at least one bracket and configured for releasable attachment to the rail;
a shoe assembly including at least one of a first shoe and a second shoe, and an adapter releasably attached to one of said first and second shoe, said assembly constructed and arranged for increasing traction between a standard ladder foot and a ground surface by engaging a contact surface area of the foot;
a spike slidably received in said bracket and having a distal end configured for attachment to said adapter for stabilizing the ladder during use; and
at least one cam assembly attached to said frame and each including at least one radially expanding element for frictionally engaging an inner diameter of a hollow rung for achieving a secure friction fit between said frame and the rail.

19. The ladder accessory of claim 18 wherein said wedges are linearly offset from each other along said shaft and include a pair of outer wedges threadably received on said shaft, and a middle wedge defining a channel constructed and arranged for being loosely received on said shaft, such that upon insertion into said hollow rung, said shaft is tightened by a tool, threadably tightening said outer wedges toward each other and pushing said middle wedge radially away from said shaft along said channel, radially expanding a diameter of said cam assembly and securing said frame to the rail.

20. The ladder accessory of claim 18 wherein said first shoe includes a first plate member having a rubber-like pad attached thereto, and said second shoe includes a plurality of spikes extending from a second plate member thereof, said rubber-like pad and said spikes configured for engaging said ground surface and increasing traction on said ground surface.
